(19) United States
(12) Patent Application Publication
(10) Pub. No.: US 2025/0267013 A1
(43) Pub. Date: Aug. 21, 2025

(54) PUBLIC KEY INFRASTRUCTURE ATTRIBUTE CERTIFICATE TWEAK (PACT)

(71) Applicant: Wells Fargo Bank, N.A., San Francisco, CA (US)

(72) Inventors: Jeffrey J. Stapleton, O'Fallon, MO (US); Peter Bordow, Fountain Hills, AZ (US)

(73) Assignee: Wells Fargo Bank, N.A., San Francisco, CA (US)

(21) Appl. No.: 19/041,089

(22) Filed: Jan. 30, 2025

Related U.S. Application Data
(60) Provisional application No. 63/554,086, filed on Feb. 15, 2024.

(51) Int. Cl. H04L 9/32; H04L 9/30

(52) U.S. Cl. CPC H04L 9/3263; H04L 9/30

(57) ABSTRACT

The present disclosure is directed to systems, methods, and non-transitory computer-readable media for receiving, by a relying party device from a subject device, an attribute certificate of a subject corresponding to the subject device, wherein the attribute certificate identifies a plurality of public key certificates, each of the plurality of public key certificates is part of a certificate chain, each of the plurality of public key certificates comprises a public key of the subject, selecting, by the relying party device, a public key certificate of the plurality of public key certificates using the attribute certificate, performing, by the relying party device, certificate chain validation of a certificate chain of the selected public key certificate, and in response to the certificate chain validation being successful, using, by the relying party device, a public key comprised in the selected public key certificate in a cryptographic operation.

### CROSS-REFERENCE TO RELATED APPLICATION

This application claims priority to U.S. Patent Application No. 63/554,086, filed Feb. 15, 2024, the full disclosure of which is incorporated herein for reference in its entirety.

### BACKGROUND

In a Public Key Infrastructure (PKI), a Certificate Authority (CA) can issue a certificate (e.g., a digital certificate, a public key certificate, and so on) having a subject associated with a subject public key. In other words, in a PKI, a CA issues a signed certificate associating a subject with a public key. The CA's signature on the certificate cryptographically binds the CA's name, the subject's name, and the subject's public key together, along with other certificate information. A relying party obtains the certificate of the subject and obtains from the certificate the issuing entity (e.g., the issuing CA), the subject, and the subject public key. The relying party also obtains one or more CA certificates to obtain one or more public keys of the PKI in order to validate the certificate chain and verify the certificate of the subject. Upon establishing trust in the subject certificate via certificate validation in which the relying party validates the trust in the subject certificate and the CA certificate, the subject and the relying party can establish other cryptographic keys, exchange or communicate encrypted data, signed messages, digital signatures, and so on.

### SUMMARY

The arrangements disclosed herein relate to systems, methods, and non-transitory computer-readable media for receiving, by a relying party device from a subject device, an attribute certificate of a subject corresponding to the subject device, wherein the attribute certificate identifies a plurality of public key certificates, each of the plurality of public key certificates is part of a certificate chain, each of the plurality of public key certificates comprises a public key of the subject, selecting, by the relying party device, a public key certificate of the plurality of public key certificates using the attribute certificate, performing, by the relying party device, certificate chain validation of a certificate chain of the selected public key certificate, and in response to the certificate chain validation being successful, using, by the relying party device, a public key comprised in the selected public key certificate in a cryptographic operation.

The arrangements disclosed herein relate to systems, methods, and non-transitory computer-readable media for sending, by a subject device to a relying party device, an attribute certificate of a subject corresponding to the subject device, wherein the attribute certificate identifies a plurality of public key certificates of the subject, each of the plurality of certificates is part of a certificate chain, each of the plurality of certificates comprises a public key of the subject; and sending, by the subject device to the relying party device, a public key certificate of the plurality of public key certificates, wherein the public key certificate is selected by the relying party device, wherein the relying party device performs certificate chain validation of a certificate chain of the selected public key certificate.

These and other features, together with the organization and manner of operation thereof, will become apparent from the following detailed description when taken in conjunction with the accompanying drawings.

### BRIEF DESCRIPTION OF THE DRAWINGS

FIG. 1A is a schematic diagram illustrating an example method for Public Key Infrastructure Attribute Certificate Tweak (PACT), according to various arrangements. FIG. 1B is a schematic diagram illustrating an example method for Public Key Infrastructure Attribute Certificate Tweak (PACT), according to various arrangements. FIG. 1B is a schematic diagram illustrating an example method for validating certificate chains 111 and 151 used for PACT, according to various arrangements. FIG. 2 illustrates block diagrams of a classical computer and a quantum computer, according to various arrangements.

FIG. 3 is a table illustrating a public key certificate, according to various arrangements (e.g., X.509).

FIG. 4 is a table illustrating subfields of each extension field of a public key certificate, according to various arrangements (e.g., X.509).

FIG. 5 is a table illustrating an attribute certificate, according to various arrangements (e.g., X.509).

FIG. 6 is a table illustrating subfields of each attributes field of the attribute certificate, according to various arrangements, (e.g., X.509).

FIG. 7 shows examples of structures of certificate attributes an, according to various arrangements (e.g., X.509).

FIG. 8 is a flowchart diagram illustrating an example method for PACT performed by a relying party device, according to various arrangements.

FIG. 9 is a flowchart diagram illustrating an example method for PACT performed by a subject device, according to various arrangements.

### DETAILED DESCRIPTION

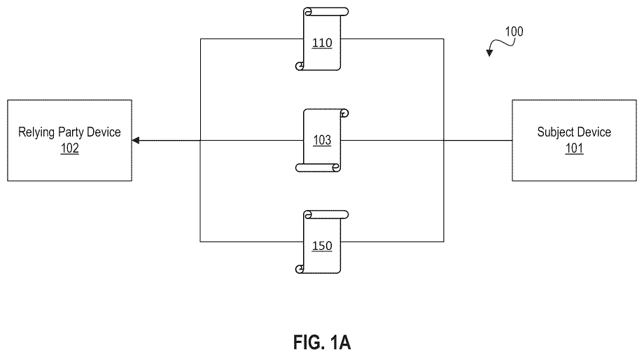

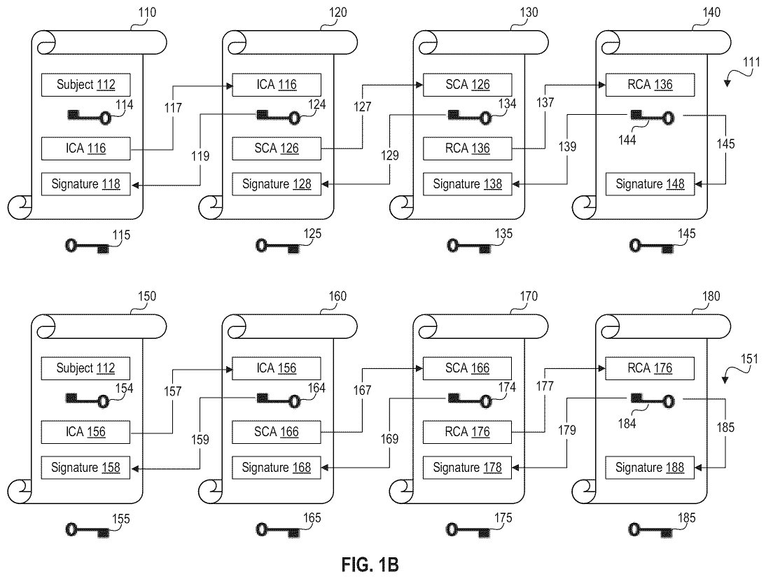

The arrangements described herein relate to systems, apparatuses, methods, and non-transitory computer-readable media for utilizing attribute certificates to determine or select a subject certificate and its corresponding certificate chain to be used for cryptographic operations involving a relying party. Examples of cryptographic operations include encrypting data, decrypting data, encrypting cryptographic material (e.g., a cryptographic key), decrypting another cryptographic material, signing data, verifying a digital signature, signcrypting data, de-signcrypting data, establishing another cryptographic key, and so on using the subject's public key. In some arrangements, the subject and the relying party can negotiate which certificate (and its corresponding certificate chain) to use for a cryptographic operation using the attribute certificate. For example, the relying party receives the attribute certificate (e.g., the attribute certificate 103 in FIG. 1A) and at least one associated single-key certificate chain from the subject. The attribute certificate provides sufficient information for the relying party to choose and validate the subject's certificate chain and use the appropriate subject's public key.

Cryptographic transitions from one algorithm to another, or even from one key length to another, have always been problematic. The inevitable cryptanalysis by a Cryptographically Relevant Quantum Computer (CRQC) poses a worldwide threat. In addition, multiple Post Quantum Cryptography (PQC) transitions pose enormous challenges to long-established cryptographic frame works. As discussed in further details herein, attribute certificates can provide subjects and relying parties with a reliable mechanism to bridge the gap between different cryptographic protocols or between conventional cryptography and PQC. For example, the subject provides its attribute certificate (obtained from an Attribute Authority (AA)) and at least one public key certificate (obtained from at least one CA) to the relying party. In some examples, the AA can be a part of CA services or an independent third party service. The attribute certificate can refer to its own certificate chain per the AA public key certificate.

FIG. 1A is a schematic diagram illustrating a system 100 for implementing PACT, according to various arrangements. The system 100 includes a subject device 101 and a relying party device 102. The subject device 101 includes at least one a device, server, or computing system used by a subject, which is the name of an owner of cryptographic keys (e.g., the public key) included in a plurality of public key certificates (e.g., the certificates 110 and 150). The certificates 110 and 150 each includes a cryptographic key (e.g., a public key) and can be referred to as public key certificates, digital certificates, and so on. The relying party device 102 includes at least one a device, server, or computing system used by a relying party, which can rely on the certificates 110 and 150 and use the cryptographic key included in at least one of the certificates 110 and 150 in cryptographic operations (e.g., cryptographic processes or cryptographic algorithms to encrypt, decrypt, validate, authenticate, or protect sensitive information) in response to performing certificate chain validation (as shown in FIG. 1B) on a certificate chain of each of the at least one of the certificates 110 and 150. While two certificates 110 and 150 are shown for illustrative purposes, the present arrangements described with respect to two certificates 110 and 150 can be likewise implemented for three or more public key certificates in a chain.

In some arrangements, the subject device 101 can send, via a network, an attribute certificate 103 of the subject. In some examples, revocation services, such as Certificate Revocation List (CRL) and Online Certificate Status Protocol (OCSP) can be used to determine whether the certificate 103 (or any certificate in a certificate chain of the certificate 103) is revoked. In response to determining that the certificate is not revoked and certificate validation (e.g., certificate chain validation) is performed, the validated certificate can be relied upon. On the other hand, in response to determining that the certificate is revoked, the certificate validation fails and the certificate cannot be relied upon. The attribute certificate 103 identifies the certificates 110 and 150 and attributes associated thereto. Based on the attributes contained in the attribute certificate 103, the relying party computing device 102 can select one of the certificates 110 and 150, performs certificate chain validation on the selected certificate, and in response to successfully performing the certificate chain validation, use the cryptographic key in the selected certificate in a cryptographic operation. The subject device 101 can send at least one of the certificates 110 and 150 to the relying party device 102 via the network. The subject device 101 can send the at least one of the certificates 110 and 150 and the attribute certificate 103 using a security protocol (e.g., Transport Layer Security (TLS)) via the network.

In some examples, the subject device 101 can send, via the network, the certificates 110 and 150 to the relying party device 102 before sending the attribute certificate 103 or along with (simultaneously with) the attribute certificate 103, such that the relying party device 102 can subsequently select one of the received certificates 110 and 150 using the attributes contained in the attribute certificate 103.

In some examples, the subject device 101 can send, via the network, the selected one of the certificates 110 and 150 to the relying party device 102 after sending the attribute certificate 103 via the network, such that the relying party device 102 can select one of the certificates 110 and 150 using the attributes contained in the attribute certificate 103 first and then sends an indication of the selected certificate to the subject device 101 via the network. In this case, the subject device 101 can pre-share the attribute certificate 103 in advance of sending the certificates 110 and 150. In response, the subject device 101 sends the selected one of the certificates 110 and 150 to the relying party device 102 according to the indication.

In some examples, the certificates 110 and 150 can be stored locally in (e.g., in a local memory of) the relying party device 102 or stored in a third-party database external to the relying party device 102 or the subject device 101 (e.g., in a network node different from those of the relying party device 102 or the subject device 101). In some examples in which the certificates 110 and 150 are locally stored, in response to receiving the attribute certificate 103 from the subject device 101 via the network, the relying party device 102 can subsequently select one of the locally stored certificates 110 and 150 using the attributes contained in the attribute certificate 103. In some examples in which the certificates 110 and 150 are stored in a third-party database, in response to receiving the attribute certificate 103 from the subject device 101 via the network, the relying party device 102 subsequently selects one of the certificates 110 and 150 using the attributes contained in the attribute certificate 103 sends an indication of the selected certificate to the third-party database via the network. In response, the third-party database sends the selected one of the certificates 110 and 150 to the relying party device 102 according to the indication.

In some examples, the relying party device 102 can send a request to the subject device 101 for the attribute certificate 103. In response to receiving the request, the subject device 101 sends the attribute certificate 103 to the relying party device 102. Accordingly, the attribute certificate 103 of the subject can be fetched on-demand as a service.

The attribute certificate 103 includes information regarding the certificates 110 and 150, such as identifying information of the certificates 110 and 150 and attributes of the certificates 110 and 150. In some examples, the identifying information of a public key certificate includes for example a serial number or ID of the public key certificate, an issuer name of the public key certificate, a version number, a link or address at which the public key certificate can be obtained (e.g., received or requested), and so on. In some examples, the attributes of a public key certificate (or a digital certificate) include characteristics of the that public key certificate with which the relying party device 102 can compare its own capabilities to select one of a plurality of public key certificates to use for a cryptographic operation.

The attributes of a public key certificate include one or more of a protocol (e.g., legacy/classical, PQC, and so on) of a cryptographic key (e.g., a public key) in the public key certificate, a key management or signature algorithm of the cryptographic key in the public key certificate, standard setting body (e.g., NIST) that sets the standard or specification followed by the algorithms of the cryptographic key in the public key certificate, a version number or agreement number of the public key certificate, a specification of the cryptographic key in the public key certificate, a key length of the cryptographic key in the public key certificate, an expiration date of the public key certificate, a type of access allowed using the cryptographic key in the public key certificate, an application allowed using the cryptographic key in the public key certificate, and so on.

In some examples, the attributes include an indication that a public key in a public key certificate is defined using a Post Quantum Cryptography (PQC) protocol or a classical/legacy/non-PQC protocol. Given that a public key defined (e.g., generated) using the PQC protocol can be used by a relying party device 102 that is or has access to a quantum computer, a relying party device 102 that is not or has no access to a quantum computer cannot utilize a PQC public key. In such examples, the relying party device 102, which may be a classical computer, can select a classical/legacy/non-PQC public key and a public key certificate associated thereto instead. On the other hand, a relying party device 102 that is or has access to a quantum computer can utilize a PQC public key. In such examples, the relying party device 102 can select a PQC public key and a public key certificate associated thereto.

Examples of PQC key management or signature algorithms include Crystals-Dilithium, Crystals-Kyber, Key-Encapsulation Mechanism (KEM), Module Lattice-based KEM (ML-KEM), SPHINCS, Pair-Wise Key-Establishment Schemes Using Discrete Logarithm-Based Cryptography, Pair-Wise Key Establishment Schemes Using Integer Factorization Cryptography, Module-Lattice-Based Digital Signature Standard, Stateless Hash-Based Digital Signature Standard, FALCON, etc. Examples of classical, key management or signature algorithms include Diffie-Hellman (DH), Elliptical Curve DH (ECDH), ephemeral keys, Rivest-Shamir-Adleman (RSA), and so on. For example, a relying party device 102 configured for one or more types of key management or signature algorithms in terms of hardware, software, and firmware can select a public key and a public key certificate associated thereto according to the capabilities of the relying party device 102, e.g., in the case that the relying party device 102 has capabilities to meet a given key management or signature algorithm, the relying party device 102 can select that key management or signature algorithm.

Similarly, the relying party device 102 can be configured in terms of hardware, software, and firmware for at least one given version of a public key, a key management or signature algorithm, at least one given specification of the public key, at least one given key management or signature algorithm, at least one given key length of a public key, and so on. The relying party device 102 can select a public key and a public key certificate associated thereto according to such capabilities.

The relying party device 102 can select a public key and a public key certificate associated thereto according to an expiration date of the public key certificate. That is, the relying party device 102 can select a public key certificate and a public key contained therein in response to determining that the expiration date has not passed or in response to determining that the expiration date is at least a predetermined time interval after the current time.

Examples of the types of access allowed a public key certificate and its public key can be used include wire transfer, accessing online backing, transferring an amount over or under a threshold, geolocation of the transferee, and so on. In some examples, the capabilities of the relying party device 102 includes intended usage of a public key. For example, the intended usage includes types of transactions (e.g., wire transfer, P2P transfer, and so on), types of access (e.g., accessing online backing, transferring funds), intended transferee, and so on. The relying party device 102 can select a public key and a public key certificate associated thereto according to such capabilities.

In an example in which the relying party device 102 intends to select a public key for wire transfer, the relying party device 102 selects a public key having an attribute that allows wire transfers. In an example in which the relying party device 102 intends to select a public key for transferring funds, the relying party device 102 selects a public key having an attribute that allows transferring funds. In an example in which the relying party device 102 intends to select a public key for an intended transferee located in a geolocation or within an area, the relying party device 102 selects a public key having an attribute that allows transferring funds to a transferee located in that geolocation or within that area. In an example in which the relying party device 102 intends to select a public key for access one of multiple applications on a site, the relying party device 102 selects a public key having an attribute that allows the public key to be used for that application on that side.

In some implementation, applications with restricted access and sensitive information, transfer of funds above a certain threshold, transfers with transferees located in a certain area or outside of a certain area require additional protection, thus, the relying party device 102 can select a public key that has a more hardware-intensive protocol (e.g., PQC), more complex and secure key management or signature algorithm, more reputable standard setting body, more recent versions and specifications, longer key length, and so on.

On the other hand, applications with open access and no sensitive information, transfer of funds below a certain threshold, transfers with transferees located in a certain area or outside of a certain area require less protection, thus, the relying party device 102 can select a public key that has a less hardware-intensive protocol (e.g., classical), less complex and secure key management or signature algorithm, less reputable standard setting body, less recent versions and specifications, shorter key length, and so on, to improve processing efficiency and delay.

The relying party device 102 is aware of its own capabilities and can store its list of its capabilities in an internal memory. In response to determining that the capabilities of the relying party device 102 meets all attributes or at least one attribute of a public key certificate, the relying party device 102 can select that public key certificate. In response to determining that the capabilities of the relying party device 102 do not meet at least one attribute or all attributes of a public key certificate, the relying party device 102 does not select that public key certificate.

In some implementations, most relying party devices 102 are set up to process attribute certificates and the information contained therein. Presently, the attribute certificates are not being used for public key certificate selection. By including attributes (e.g., protocols, algorithms, etc.) of the public key certificates of a subject in the attribute certificate and providing that attribute certificate to the relying party device 102 for selection, the relying party device 102 and the subject device 1010 can negotiate which certificate/certificate chain to use without complicated or costly new implementations such as X.509 Dual-Key Certificates, IETF Composite Certificates, IETF Chameleon Certificates, and so on. Attribute certificates were added to X.509 over a decade ago in the year 2000 and many computer systems support attribute certificates.

Telecommunication standards such as the Telecommunication Standardization Sector (ITU-T) X.509 Recommendation defines several types of certificates including an End-Entity (EE) certificate, also referred to as a public key certificate, which is issued to an entity (e.g., an end entity or an end entity device) by a CA or an AA. The CA or AA signs the EE certificate using its private signature key such that any relying party or relying party device 102 can verify the EE certificate signature using the CA or AA public key, which is contained in a CA certificate or an AA certificate.

In some examples, an AA certificate is an attribute certificate for one AA issued by another AA or by the same AA. In some examples, an attribute certificate includes a data structure that is digitally signed by an AA that binds some attribute values with identification information about its holder. In some examples, a CA certificate is a public-key certificate for one CA issued by another CA or by the same CA. In some examples, a public key certificate contains the public key of an entity (e.g., the subject or the subject device 101), together with some other information, rendered unforgeable by digital signature with the private key of the CA that issued the public key certificate.

In some arrangements, in the PKI X.509 scheme or PKIX, a certification chain includes an EE certificate, an Issuing CA (ICA) certificate, one or more Subordinary CA (SCA) certificates, and a Root CA (RCA) certificate. The EE certificate signature is verified using the ICA certificate. The ICA certificate signature is verified using the SCA certificate. The SCA certificate signature is verified using the RCA certificate. The RCA certificate signature is verified using the RCA certificate. The relationships between the EE, ICA, SCA, and RCA are referred to as the certificate chain which the relying party device 102 validates (e.g., via certificate validation) to confirm the validity of the certificates. The ICA, SCA, and RCA are components of a PKI operated by either a public or private CAs.

A PKI hierarchy includes nodes and the corresponding Registration Authority (RA). Each of the nodes in the PKI hierarchy can include or represents a CA such as a RCA, an intermediary CA or SCA, or ICA. That is, a PKI has a hierarchy including one or more CAs. For example an ICA signs a certificate of the end entity device using a private key of the ICA. An SCA signs a certificate of the ICA using a private key of the SCA. The RCA signs a certificate of the SCA and its own RCA certificate using a private key of the RCA. The RCA, SCA, and ICA certificates are typically downloaded by the relying party device 102 and stored in a trusted environment for later use.

FIG. 1B is a schematic diagram illustrating an example method for validating certificate chains 111 and 151 used for PACT, according to various arrangements. In some examples, the attribute certificate 103 can be validated by the relying party device 102 (e.g., via certificate chain validation similar to those shown in FIG. 1B for the certificate chains 111 and 151) before the information (e.g., identifying information and the attributes of the certificates 110 and 150) is relied on by the relying party device 102 for selecting the certificate 110 or 150. In response to selecting the public key certificate 110, the relying party device 102 validates the certificate chain 111 of the public key certificate 110. In response to selecting the public key certificate 150, the relying party device 102 validates the certificate chain 151 of the public key certificate 150.

The certificate chain 111 includes the public key certificate 110 (also referred to as a subject certificate 110), an ICA certificate 120, an SCA certificate 130, and an RCA certificate 140. While the SCA certificate 130 is shown in FIG. 1B, other examples may not be implemented with any SCA certificate. The subject certificate 110 is validated through certificate chain validation method. The subject certificate 110 is also referred to as an EE certificate. In some arrangements, the ICA issues the subject certificate 110, and the RCA issues the ICA certificate 120, the SCA certificate 130, and the RCA certificate 140. In some examples, issuing a certificate means a CA signs the certificate with its private key.

A relying party device 102 can obtain (e.g., receive) the subject certificate 110 from the subject device 101. For example, a relying party device 102 can receive signed data (e.g., a signed message, signed code, signed document, signed file, signed program or application, and so on) and the subject certificate 110. The data is signed by the subject device 101 using a private key of the subject device 101. The relying party device 102 can also obtain the subject certificate 110 (e.g., the EE certificate of the subject device 101) from the subject device 101 with the signed data. The relying party device 102 validates the certificate chain 111 of the subject certificate 110 using the public key of the associated CA along with other certificate parameters (e.g., validity dates, key usage, etc.) and then uses the public key 114 of the subject device 101 to verify the signature 118 in the signed data 105.

For example, in response to receiving the signed data and the subject certificate 110 of the subject device 101, the relying party device 102 confirms the parameters of the subject certificate 110 and determines or otherwise identifies the ICA certificate 120, at 117. In some examples, revocation services, such as CRL and OCSP can be used to determine whether a certificate is revoked. In response to determining that the certificate is not revoked and certificate validation (e.g., certificate chain validation) is performed, the validated certificate can be relied upon. On the other hand, in response to determining that the certificate is revoked, the certificate validation fails and the certificate cannot be relied upon.

In some arrangements, the subject certificate 110 of the subject device 101 includes information such as a subject 112, a public key 114, ICA information 116 identifying an ICA, and a signature 118 of the ICA. The subject 112 identifies origin of the certificate 110, such as the end entity or the subject device 101, or the device from which the signed data originates. Examples of the subject 112 includes a name of an individual, company, organization, device, an application, or so on associated with the end entity or the subject device 101. The subject certificate 110 can be parsed to determine the ICA information 116. In some examples, the ICA information 116 includes identifying information of the ICA, such as an ICA name, an ICA index, an ICA identifier, an ICA number, a link (e.g., a Uniform Resource Locator (URL), a Uniform Resource Name (URN), or Uniform Resource Identifier (URI)) to the ICA or the ICA certificate 120.

The subject certificate 110 (e.g., the key usage field and extended key usage field) includes other information such as validity dates, key usage, and so on. In response to obtaining the subject certificate 110, such information can be parsed by the relying party device 102 and confirmed or verified. For example, the relying party device 102 can verify the validity dates against a current date to determine whether the subject certificate 110 is currently valid. The relying party device 102 can verify the usage designed in the subject certificate 110 against the present usage (e.g., to verify the signature on the signed data). This is referred to as confirming the parameters of the subject certificate 110. In some examples, in response to confirming the parameters of the subject certificate 110, the relying party device 102 determines or otherwise identifies the ICA certificate 120 according to the ICA information 116, at 117. For example, the relying party device 102 can access or find the ICA certificate 120 using the identifying information of the ICA certificate 120 or the ICA in the ICA information 116.

In response to accessing or finding the ICA certificate 120, the relying party device 102 confirms the parameters of the ICA certificate 120 and determines or otherwise identifies the SCA certificate 130, at 127.

In some arrangements, the ICA certificate 120 includes information such as the ICA information 116, a public key 124, SCA information 126 identifying an SCA, and a signature 128 of the SCA. The ICA certificate 120 can be parsed to determine the SCA information 126. In some examples, the SCA information 126 includes identifying information of the SCA, such as an SCA name, an SCA index, an SCA identifier, an SCA number, a link (e.g., a URL, a URN, or URI) to the SCA or the SCA certificate 130.

The ICA certificate 120 (e.g., the key usage field and extended key usage field) includes other information such as validity dates, key usage, and so on. In response to obtaining the ICA certificate 120, such information can be parsed by the relying party device 102 and confirmed or verified. For example, the relying party device 102 can verify the validity dates against a current date to determine whether the ICA certificate 120 is currently valid. The relying party device 102 can verify the usage designed in the ICA certificate 120 against the present usage (e.g., to verify the signature on the signed data or certificate chain validation). This is referred to as confirming the parameters of the ICA certificate 120. In some examples, in response to confirming the parameters of the ICA certificate 120, the relying party device 102 determines or otherwise identifies the SCA certificate 130 according to the SCA information 126, at 127. For example, the relying party device 102 can access the SCA certificate 130 using the identifying information of the SCA certificate 130 or the SCA in the SCA information 126.

In response to accessing or finding the SCA certificate 130, the relying party device 102 confirms the parameters of the SCA certificate 130 and determines or otherwise identifies the RCA certificate 140, at 137.

In some arrangements, the SCA certificate 130 includes information such as the SCA information 126, a public key 134, RCA information 136 identifying an RCA, and a signature 138 of the RCA. The SCA certificate 130 can be parsed to determine the RCA information 136. In some examples, the RCA information 136 includes identifying information of the RCA, such as an RCA name, an RCA index, an RCA identifier, an RCA number, a link (e.g., a URL, a URN, or URI) to the RCA or the RCA certificate 140.

The SCA certificate 130 (e.g., the key usage field and extended key usage field) includes other information such as validity dates, key usage, and so on. In response to obtaining the SCA certificate 130, such information can be parsed by the relying party device 102 and confirmed or verified. For example, the relying party device 102 can verify the validity dates against a current date to determine whether the SCA certificate 130 is currently valid. The relying party device 102 can verify the usage designed in the SCA certificate 130 against the present usage (e.g., to verify the signature on the signed data or certificate chain validation). This is referred to as confirming the parameters of the SCA certificate 130. In some examples, in response to confirming the parameters of the SCA certificate 130, the relying party device 102 determines or otherwise identifies the RCA certificate 140 according to the RCA information 136, at 137. For example, the relying party device can access the RCA certificate 140 using the identifying information of the RCA certificate 140 or the RCA in the RCA information 136.

In response to accessing or finding the RCA certificate 140, the relying party device 102 confirms the parameters of the RCA certificate 140. The RCA certificate 140 (e.g., the key usage field and extended key usage field) includes other information such as validity dates, key usage, and so on. In response to obtaining the RCA certificate 140, such information can be parsed by the relying party device 102 and confirmed or verified. For example, the relying party device 102 can verify the validity dates against a current date to determine whether the RCA certificate 140 is currently valid. The relying party device 102 can verify the usage designed in the RCA certificate 140 against the present usage (e.g., to verify the signature on the signed data or certificate chain validation). This is referred to as confirming the parameters of the RCA certificate 140. In some examples, in response to confirming the parameters of the RCA certificate 140, the relying party device 102 can validate the certificates 140, 130, 120 and 110.

In some arrangements, the RCA certificate 140 includes information such as a public key 144. The RCA certificate 140 includes a signature 148 of the RCA. The relying party device 102 can use the public key 144 of the RCA to verify the signature 148 in the RCA certificate 140, at 145. At 139, the relying party device 102 can use the public key 144 of the RCA to verify the signature 138 in the SCA certificate 130. At 129, the relying party device 102 can use the public key 134 of the SCA to verify the signature 128 in the ICA certificate 120. At 119, the relying party device 102 can use the public key 124 of the ICA to verify the signature 118 in the subject certificate 110.

Upon successfully completing certificate chain validation, the relying party device 102 can use the subject public key 114 per its key usage for a cryptographic operation, including verifying a digital signature on the signed data. In some examples, the relying party device 102 can use the subject public key 114 in other cryptographic operations such as establishing a symmetric key, decrypting ciphertext, and so on. In response to determining that certificate chain validation has failed, the relying party device 102 stops trusting the subject certificate.

In some examples, a private key 115 is mathematically related to the public key 114, e.g., the private key 115 and the public key 114 form a public/private key pair. Asymmetric private and public keys are mathematically related, unlike symmetric keys. The subject device 101 can use the private key 115 to sign the data or decrypt data. In some examples, the subject device 101 secures the private key 115 in an HSM or a cryptographic software module.

In some examples, a private key 125 is mathematically related to the public key 124, e.g., the private key 125 and the public key 124 form a public/private key pair. The ICA signs the certificate 110 (e.g., generate the signature 118) via a digital signature algorithm using the private key 125.

In some examples, a private key 135 is mathematically related to the public key 134, e.g., the private key 135 and the public key 134 form a public/private key pair. The SCA signs the certificate 120 (e.g., generate the signature 138) via a digital signature algorithm using the private key 135.

In some examples, a private key 145 is mathematically related to the public key 144, e.g., the private key 145 and the public key 144 form a public/private key pair. The RCA signs the certificates 130 and 140 (e.g., generate the signatures 138 and 148) via a digital signature algorithm using the private key 145.

The certificate chain 151 includes the public key certificate 150 (also referred to as a subject certificate 150), an ICA certificate 160, an SCA certificate 170, and an RCA certificate 180. While the SCA certificate 170 is shown in FIG. 1B, other examples may not be implemented with any SCA certificate. The subject certificate 150 is validated through certificate chain validation method. The subject certificate 150 is also referred to as an EE certificate. In some arrangements, the ICA issues the subject certificate 150, and the RCA issues the ICA certificate 160, the SCA certificate 170, and the RCA certificate 180.

A relying party device 102 can obtain (e.g., receive) the subject certificate 150 from the subject device 101. For example, a relying party device 102 can receive signed data (e.g., a signed message, signed code, signed document, signed file, signed program or application, and so on) and the subject certificate 150. The data is signed by the subject device 101 using a private key of the subject device 101. The relying party device 102 can also obtain the subject certificate 150 (e.g., the EE certificate of the subject device 101) from the subject device 101 with the signed data. The relying party device 102 validates the certificate chain 151 of the subject certificate 150 using the public key of the associated CA along with other certificate parameters (e.g., validity dates, key usage, etc.) and then uses the public key 154 of the subject device 101 to verify the signature 158 in the signed data 105.

For example, in response to receiving the signed data and the subject certificate 150 of the subject device 101, the relying party device 102 confirms the parameters of the subject certificate 150 and determines or otherwise identifies the ICA certificate 160, at 157. In some examples, revocation services, such as CRL and OCSP can be used to determine whether a certificate is revoked. In response to determining that the certificate is not revoked and certificate validation (e.g., certificate chain validation) is performed, the certificate can be relied upon. On the other hand, in response to determining that the certificate is revoked, the certificate validation fails and the certificate cannot be relied upon.

In some arrangements, the subject certificate 150 of the subject device 101 includes information such as a subject 112, a public key 154, ICA information 156 identifying an ICA, and a signature 158 of the ICA. The subject 112 identifies origin of the certificate 150, such as the end entity or the subject device 101, or the device from which the signed data originates. Examples of the subject 112 includes a name of an individual, company, organization, device, an application, or so on associated with the end entity or the subject device 101. The subject certificate 150 can be parsed to determine the ICA information 156. In some examples, the ICA information 156 includes identifying information of the ICA, such as an ICA name, an ICA index, an ICA identifier, an ICA number, a link (e.g., a URL, a URN, or URI) to the ICA or the ICA certificate 160.

The subject certificate 150 (e.g., the key usage field and extended key usage field) includes other information such as validity dates, key usage, and so on. In response to obtaining the subject certificate 150, such information can be parsed by the relying party device 102 and confirmed or verified. For example, the relying party device 102 can verify the validity dates against a current date to determine whether the subject certificate 150 is currently valid. The relying party device 102 can verify the usage designed in the subject certificate 150 against the present usage (e.g., to verify the signature on the signed data). This is referred to as confirming the parameters of the subject certificate 150. In some examples, in response to confirming the parameters of the subject certificate 150, the relying party device 102 determines or otherwise identifies the ICA certificate 160 according to the ICA information 156, at 157. For example, the relying party device 102 can access or find the ICA certificate 160 using the identifying information of the ICA certificate 160 or the ICA in the ICA information 156.

In response to accessing or finding the ICA certificate 160, the relying party device 102 confirms the parameters of the ICA certificate 160 and determines or otherwise identifies the SCA certificate 170, at 167.

In some arrangements, the ICA certificate 160 includes information such as the ICA information 156, a public key 164, SCA information 166 identifying an SCA, and a signature 168 of the SCA. The ICA certificate 160 can be parsed to determine the SCA information 166. In some examples, the SCA information 166 includes identifying information of the SCA, such as an SCA name, an SCA index, an SCA identifier, an SCA number, a link (e.g., a URL, a URN, or URI) to the SCA or the SCA certificate 170.

The ICA certificate 160 (e.g., the key usage field and extended key usage field) includes other information such as validity dates, key usage, and so on. In response to obtaining the ICA certificate 160, such information can be parsed by the relying party device 102 and confirmed or verified. For example, the relying party device 102 can verify the validity dates against a current date to determine whether the ICA certificate 160 is currently valid. The relying party device 102 can verify the usage designed in the ICA certificate 160 against the present usage (e.g., to verify the signature on the signed data or certificate chain validation). This is referred to as confirming the parameters of the ICA certificate 160. In some examples, in response to confirming the parameters of the ICA certificate 160, the relying party device 102 determines or otherwise identifies the SCA certificate 170 according to the SCA information 166, at 167. For example, the relying party device 102 can access the SCA certificate 170 using the identifying information of the SCA certificate 170 or the SCA in the SCA information 166.

In response to accessing or finding the SCA certificate 170, the relying party device 102 confirms the parameters of the SCA certificate 170 and determines or otherwise identifies the RCA certificate 180, at 177.

In some arrangements, the SCA certificate 170 includes information such as the SCA information 166, a public key 174, RCA information 176 identifying an RCA, and a signature 178 of the RCA. The SCA certificate 170 can be parsed to determine the RCA information 176. In some examples, the RCA information 176 includes identifying information of the RCA, such as an RCA name, an RCA index, an RCA identifier, an RCA number, a link (e.g., a URL, a URN, or URI) to the RCA or the RCA certificate 180.

The SCA certificate 170 (e.g., the key usage field and extended key usage field) includes other information such as validity dates, key usage, and so on. In response to obtaining the SCA certificate 170, such information can be parsed by the relying party device 102 and confirmed or verified. For example, the relying party device 102 can verify the validity dates against a current date to determine whether the SCA certificate 170 is currently valid. The relying party device 102 can verify the usage designed in the SCA certificate 170 against the present usage (e.g., to verify the signature on the signed data or certificate chain validation). This is referred to as confirming the parameters of the SCA certificate 170. In some examples, in response to confirming the parameters of the SCA certificate 170, the relying party device 102 determines or otherwise identifies the RCA certificate 180 according to the RCA information 176, at 177. For example, the relying party device can access the RCA certificate 180 using the identifying information of the RCA certificate 180 or the RCA in the RCA information 176.

In response to accessing or finding the RCA certificate 180, the relying party device 102 confirms the parameters of the RCA certificate 180. The RCA certificate 180 (e.g., the key usage field and extended key usage field) includes other information such as validity dates, key usage, and so on. In response to obtaining the RCA certificate 180, such information can be parsed by the relying party device 102 and confirmed or verified. For example, the relying party device 102 can verify the validity dates against a current date to determine whether the RCA certificate 180 is currently valid. The relying party device 102 can verify the usage designed in the RCA certificate 180 against the present usage (e.g., to verify the signature on the signed data or certificate chain validation). This is referred to as confirming the parameters of the RCA certificate 180. In some examples, in response to confirming the parameters of the RCA certificate 180, the relying party device 102 can validate the certificates 180, 170, 160 and 150.

In some arrangements, the RCA certificate 180 includes information such as a public key 184. The RCA certificate 180 includes a signature 188 of the RCA. The relying party device 102 can use the public key 184 of the RCA to verify the signature 188 in the RCA certificate 180, at 185. At 179, the relying party device 102 can use the public key 184 of the RCA to verify the signature 178 in the SCA certificate 170. At 169, the relying party device 102 can use the public key 174 of the SCA to verify the signature 168 in the ICA certificate 160. At 159, the relying party device 102 can use the public key 164 of the ICA to verify the signature 158 in the subject certificate 150.

Upon successfully completing certificate chain validation, the relying party device 102 can use the subject public key 154 per its key usage for a cryptographic operation, including verifying a digital signature on the signed data. In some examples, the relying party device 102 can use the subject public key 154 in other cryptographic operations such as establishing a symmetric key, decrypting ciphertext, and so on. In response to determining that certificate chain validation has failed, the relying party device 102 stops trusting the subject certificate 150.

In some examples, a private key 155 is mathematically related to the public key 154, e.g., the private key 155 and the public key 154 form a public/private key pair. Asymmetric private and public keys are mathematically related, unlike symmetric keys. The subject device 101 can use the private key 155 to sign the data or decrypt data. In some examples, the subject device 101 secures the private key 155 in an HSM or a cryptographic software module.

In some examples, a private key 165 is mathematically related to the public key 164, e.g., the private key 165 and the public key 164 form a public/private key pair. The ICA signs the certificate 150 (e.g., generate the signature 158) via a digital signature algorithm using the private key 165.

In some examples, a private key 175 is mathematically related to the public key 174, e.g., the private key 175 and the public key 174 form a public/private key pair. The SCA signs the certificate 160 (e.g., generate the signature 178) via a digital signature algorithm using the private key 175.

In some examples, a private key 185 is mathematically related to the public key 184, e.g., the private key 185 and the public key 184 form a public/private key pair. The RCA signs the certificates 170 and 180 (e.g., generate the signatures 178 and 188) via a digital signature algorithm using the private key 185.

In some arrangements, each of the certificates described herein, including the certificates 110, 120, 130, 140, 150, 160, 170, and 180 can be a single-key certificate. A single-key certificate includes one public key and one signature. In some arrangements, each public key 114, 124, 134, and 144 included in the certificates 110, 120, 130, and 140 in the certificate chain 111 is defined or generated using a classical/legacy/non-PQC protocol, such that the relying party device 102 that is or has access to a classical computer can perform certificate validation using the public keys 124, 134, and 144 and perform a cryptographic operation using the public key 114. In some arrangements, each public key 154, 164, 174, and 184 included in the certificates 150, 160, 170, and 180 in the certificate chain 151 is defined or generated using a PQC protocol, such that the relying party device 102 that is or has access to a quantum computer can perform certificate validation using the public keys 164, 174, and 184 and perform a cryptographic operation using the public key 154.

In some examples, one certificate chain 111 includes public keys defined or generated using the classical/legacy/non-PQC protocol and another certificate chain 151 includes public keys defined or generated using the PQC protocol. In other examples, both certificate chains 111 and 151 include public keys defined or generated using the classical/legacy/non-PQC protocol, or both certificate chains 111 and 151 include public keys defined or generated using the PQC protocol.

FIG. 2 illustrates block diagrams of a classical computer 210 and a quantum computer 220, according to various arrangements. In some examples in which the relying party device 102 is or has access to a classical computer 210 (and not a quantum computer 220), the relying party device 102 has the capability to process the classical/legacy/non-PQC protocol and not the PQC protocol. Thus, such relying party device 102 can select a public key certificate having a public key or a public key certificate chain having public keys defined or generated according to the classical/legacy/non-PQC protocol and not any public key certificate having a public key or a public key certificate chain having public keys defined or generated according to the PQC protocol.

In some examples in which the relying party device 102 is or has access to a quantum computer 220, the relying party device 102 has the capability to process the PQC protocol. Thus, such relying party device 102 can select a public key certificate having a public key or a public key certificate chain having public keys defined or generated according to the PQC protocol. Such relying party device 102 can also select aa public key certificate having a public key or a public key certificate chain having public keys defined or generated according to the classical/legacy/non-PQC protocol.

The classical computer 210 includes a processing circuit 201, a network interface circuit 204, a cryptography circuit 205, and an application circuit 206. The quantum computer 220 include a processing circuit 211, a network interface circuit 214, a cryptography circuit 215, and an application circuit 216. While various circuits, interfaces, and logic with particular functionality are shown, it should be understood that each of the classical computer 210 or the quantum computer 220 can include any number of circuits, interfaces, and logic for facilitating the functions described herein. For example, the activities of multiple circuits may be combined as a single circuit and implemented on a same processing circuit (e.g., processing circuit 201 and 211), as additional circuits with additional functionality are included.

In some arrangements, the classical computer 210 can be any number of different types of classical electronic computing devices, including for example, a personal computer, a laptop computer, a desktop computer, a mobile computer, a tablet computer, a smart phone, an application server, a catalog server, a communications server, a computing server, a database server, a file server, a game server, a mail server, a media server, a proxy server, a virtual server, a web server, or any other type and form of computing device or combinations of devices.

The processing circuit 201 includes at least one processor 202 and at least one memory 203. A processor 202 may be implemented as a general-purpose processor, a microprocessor, an Application Specific Integrated Circuit (ASIC), one or more Field Programmable Gate Arrays (FPGAs), a Digital Signal Processor (DSP), a group of processing components, or other suitable electronic processing components. In some arrangements, the processor 202 may be a multi-core processor or an array (e.g., one or more) of processors. The processor 202 may be configured to perform classical computations on a bit, which is a binary unit of information equating to one of two possible values (e.g., a ‘0’ or a ‘1’).

The memory 203 (e.g., Random Access Memory (RAM), Read-Only Memory (ROM), Non-volatile RAM (NVRAM), flash memory, hard disk storage, optical media, etc.) of processing circuit 201 stores data and/or computer instructions/code for facilitating at least some of the various processes described herein. The memory 203 includes tangible, non-transient volatile memory, or non-volatile memory. The memory 203 stores programming logic (e.g., instructions or code) that, when executed by the processor 202, controls the operations of the classical computer 210. In some arrangements, the processor 202 and the memory 203 form various processing circuits described with respect to the classical computer 210. The instructions include code from any suitable computer programming language such as, but not limited to, C, C++, C#, Java, JavaScript, VBScript, Perl, HTML, XML, Python, TCL, and Basic.

The classical computer 210 includes a network interface circuit 204 configured to establish a communication session with another device for sending and receiving data over a network. Accordingly, the network interface circuit 204 includes a cellular transceiver (supporting cellular standards), a local wireless network transceiver (supporting 802.11X, ZigBee, Bluetooth, Wi-Fi, or the like), a wired network interface, a combination thereof (e.g., both a cellular transceiver and a Bluetooth transceiver), and/or the like. In some arrangements, the classical computer 210 includes a plurality of network interface circuits 204 of different types, allowing for connections to a variety of networks, such as local area networks or wide area networks including the Internet, via different sub-networks. In some examples, the network interface circuit 204 can facilitate the classical computer 210 to send and receive data or information over the network in the manner described herein.

The classical computer 210 includes a cryptographic circuit 205 that is configured to perform cryptographic operations of the classical computer 210. The cryptographic circuit 205 can be considered as a cryptographic software module implemented using one or more of software, firmware, and hardware. In some examples, the cryptography circuit 205 can be included in or embodiment as an HSM meeting Federal Information Processing Standard (FIPS) 140-3 security level 3 or higher. For example, the cryptographic circuit 205 can perform cryptographic operations such as encrypting data, decrypting data, encrypting another cryptographic material (e.g., another cryptographic key), decrypting another cryptographic material, signing data, verifying data, signcrypting data, de-signcrypting data, establishing another cryptographic key, and so on using the public key of a selected public key certificate according to a classical/legacy/non-PQC protocol. The cryptographic circuit 205 can further perform certificate chain validation in the manner described herein for a certificate chain having public keys defined or generated according to a classical/legacy/non-PQC protocol.

The application circuit 206 executes an application, software, firmware, or code for which cryptographic operations are needed to encrypt data, decrypt data, encrypt another cryptographic material, decrypt another cryptographic material, sign data, verify data, signcrypt data, de-signcrypting data, establishing another cryptographic key, and so on. For example, the application circuit 206 can execute a mobile banking application, a browser, a word processing application, a mobile banking application, a mobile wallet, a Graphic User Interface (GUI), an email reader/client, a File Transfer Protocol (FTP) client, a virtual machine application and so on. For example, application circuit 206 can execute an application, software, firmware, or code for which data (e.g., message, code, document, file, program or application, etc.) needs to be signed or for which a signature on the signed data needs to be verified.

The quantum computer 220 is a quantum computing device can be any number of different types of quantum computing device, including for example, a superconducting quantum computer, a trapped ion quantum computer, an optical lattice based quantum computer, a quantum dot computer (spin-based or spatial-based), coupled quantum wire, a Nuclear Magnetic Resonance Quantum Computer (NMRQC), a Solid-State Nuclear Magnetic Resonance (NMR) Kane quantum computer, an electrons-on-helium quantum computer, a Cavity Quantum Electrodynamics (CQED) based quantum computer, a molecular magnet-based quantum computer, a fullerene-based Electronic Spin Resonance (ESR) quantum computer, a linear optical quantum computer, a diamond-based quantum computer, a Bose-Einstein condensate-based quantum computer, a transistor-based quantum computer, a rare-earth-metal-ion-doped inorganic crystal based quantum computer, a metallic-like carbon nanospheres based quantum computers, or any other type and form of quantum computing device or combinations of devices.

In some examples, the quantum computer 220 can be a simulated quantum computer executing an application that simulates one or more quantum computing operations capable of being performed by a quantum computing device. In some arrangements, a simulated quantum computer processes information and/or performs operations at a rate that is slower than the rate at which a quantum computer performs the same or similar operations due to the differences in performance between conventional processors configured to process logical bits and quantum logic gates configured to process quantum bits or qubits.

The processing circuit 211 of the quantum computer 220 includes at least one quantum processor 212 and at least one memory 213. The quantum processor 212 can be implemented as one or more quantum logic gates or any other suitable electronic processing component configured to perform quantum computations using quantum bits or qubits. The quantum processor 212 solves mathematical problems (e.g., integer factorization and discrete logarithms) by performing one or more quantum algorithms including algorithms based on quantum Fourier transform (e.g., Deutsch-Jozsa algorithm, Bernstein-Vazirani algorithm, Simon's algorithm, Quantum phase estimation algorithm, Shor's algorithm, Hidden subgroup problem, Boson sampling problem, Estimating Gauss sums, Fourier fishing and Fourier checking), algorithms based on amplitude amplification (e.g., Grover's algorithm, Quantum counting), algorithms based on quantum walks (e.g., element distinctness problem, triangle-finding problem, formula evaluation, group commutativity), and hybrid quantum/classical algorithms (e.g., Quantum Approximate Optimization Algorithm (QAOA), variational quantum Eigensolver, and so on).

The memory 213 of processing circuit 211 stores data and/or computer instructions/code for facilitating at least some of the various processes described herein. The memory 213 is configured to maintain a sequence of qubits representing a one, a zero, or any quantum superposition of those two qubit states. In general, a memory 213 configured to maintain n qubits can be in any superposition of up to 2ⁿ different states. For example, a pair of qubits can be in any quantum superposition of 4 states and three qubits in any superposition of 8 states. Conversely, a classical computer (e.g., the classical computer 210), may only be in one of these 2ⁿ states at any one time.

The network interface circuit 214 configured to establish a communication session with another device for sending and receiving data over a network. Accordingly, the network interface circuit 214 includes a cellular transceiver (supporting cellular standards), a local wireless network transceiver (supporting 802.11X, ZigBee, Bluetooth, Wi-Fi, or the like), a wired network interface, a combination thereof (e.g., both a cellular transceiver and a Bluetooth transceiver), and/or the like. In some arrangements, the quantum computer 220 includes a plurality of network interface circuits 214 of different types, allowing for connections to a variety of networks, such as local area networks or wide area networks including the Internet, via different sub-networks. In some examples, the network interface circuit 214 can facilitate the quantum computer 220 to send and receive data or information over the network in the manner described herein.

The quantum computer 220 includes a cryptographic circuit 215 that is configured to perform cryptographic operations of the quantum computer 220. The cryptographic circuit 215 can be considered as a cryptographic software module implemented using one or more of software, firmware, and hardware. In some examples, the cryptography circuit 215 can be included in or embodiment as an HSM meeting Federal Information Processing Standard (FIPS) 140-3 security level 3 or higher. For example, the cryptographic circuit 215 can such as encrypting data, decrypting data, encrypting cryptographic material (e.g., a cryptographic key), decrypting another cryptographic material, signing data, verifying data, signcrypting data, de-signcrypting data, establishing another cryptographic key, and so on using the public key of a selected public key certificate, according to a PQC protocol. The cryptographic circuit 205 can further perform certificate chain validation in the manner described herein for a certificate chain having public keys defined or generated according to a PQC protocol.

The application circuit 216 executes an application, software, firmware, or code for which cryptographic operations are needed to encrypt data, decrypt data, encrypt another cryptographic material, decrypt another cryptographic material, sign data, verify data, signcrypt data, de-signcrypting data, establishing another cryptographic key, and so on. For example, the application circuit 216 can execute a mobile banking application, a browser, a word processing application, a mobile banking application, a mobile wallet, a GUI, an email reader/client, an FTP client, a virtual machine application and so on. For example, application circuit 216 can execute an application, software, firmware, or code for which data (e.g., message, code, document, file, program or application, etc.) needs to be signed or for which a signature on the signed data needs to be verified.

A network can be used to send, receive, or exchange information, data, and public key certificates. For example, the network can include the Internet, a Radio Frequency (RF) network, a cellular network, a satellite link, a quantum network, an optical network, a laser network, a physical network or connection, and so on. The message can be transmitted via the Internet, RF, and cellular networks, RF signals, cellular signals, satellite signals, quantum bits or qubits, fiber optic signals, laser signals, and so on. The network can include any suitable Local Area Network (LAN), Wide Area Network (WAN), or a combination thereof. For example, the network can be supported by Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS) Wideband Code Division Multiple Access (WCDMA), Long Term Evolution (LTE), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access 1× Radio Transmission Technology (1×), General Packet Radio Service (GPRS), Personal Communications Service (PCS), 802.11X, ZigBee, Bluetooth, Wi-Fi, any suitable wired network, combination thereof, and/or the like.

Although not illustrated, in many arrangements, the network can include one or more intermediary devices, including gateways, routers, firewalls, switches, network accelerators, Wi-Fi access points or hotspots, or other devices. Any of the electronic devices and/or the network may be configured to support any application layer protocol, including without limitation, TLS, Hypertext Transfer Protocol (HTTP), and Hypertext Transfer Protocol Secure (HTTPS).

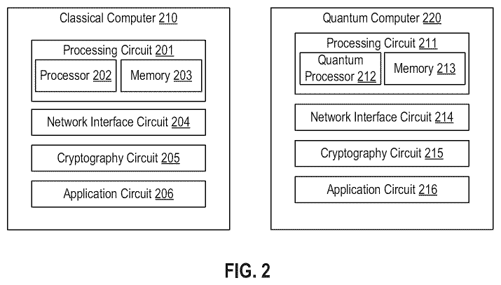

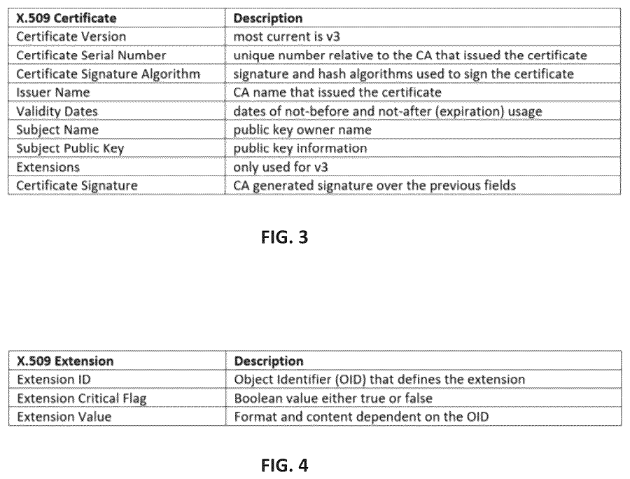

A public key certificate (e.g., the certificates 110 and 150) contains a public key 114 or 154 (e.g., a name public key, a subject public key, and so on) and is a signed object including basic fields and extensions. For example, ITU-T X.509 defines a structure and content for public key certificates, an example of which is shown in FIG. 3. The public key certificate shown in the table in FIG. 3 includes various fields including at least a certificate version, a certificate serial number, a certificate signature algorithm, an issuer name, validity dates, subject name, subject public key, extensions, and certificate signature.

The certificate version field of the public key certificate defines a version of the public key certificate, e.g., v3. The certificate serial number field of the public key certificate includes a unique number relative to the CA that issues the public key certificate. The certificate signature algorithm field of the public key certificate identifies the signature and hash algorithm used to sign the public key certificate. The issuer name field of the public key certificate identifies the name of the CA that issued the public key certificate. The validity dates field of the public key certificate includes a not-before date before which the public key certificate is invalid and a not-after date (e.g., expiration date) after which the public key certificate is invalid. In some examples, the expiration date can include a date and time e.g., YYYMMDD-HHMMSS. In some examples, a not-before is the issuance date of the certificate. The subject name field of the public key certificate identifies the name of the owner of the public key included in the public key certificate. The subject public key field of the public key certificate includes the actual public key (e.g. hexadecimal digits) and information about the public key associated with the subject. The extensions of the public key certificate typically include one or more various extensions providing additional information about the subject, the issuer, the public key, etc. The certificate signature field of the public key certificate includes the digital signature generated by the issuer CA over all the other fields and extensions of the public key certificate. In some examples, the extensions field of the public key certificate includes a basic constraint extension, which identifies that the public key certificate is an CA certificate (e.g., a certificate issued by one CA to another CA) or a subject certificate (e.g., a certificate issued by a CA to the subject identified in the subject name field).

FIG. 4 is a table illustrating the three subfields of each extension of the public key certificate, according to various arrangements (X.509). As shown, each extension includes three subfields: the extension Identifier (ID), extension critical flag, and extension value. The extension ID subfield is an Object Identifier (OID) that defines a type of the extension. The extension critical flag subfield is a Boolean value indicating whether the extension is critical (true) or non-critical (false). The extension value subfield includes a format and content of the extension, depending on the OID. Extensions marked to be critical in the extension critical flag subfield has to be processed. For example, in response to determining that the OID is unknown or unsupported, the certificate cannot be used. Accordingly, certificate validation immediately fails in response to determining that the extension is critical (per the extension critical flag subfield) and that the OID is unknown. On the other hand, in response to determining that the extension is non-critical (per the extension critical flag subfield) and that the OID is unknown or unsupported, the extension can be ignored and certificate validation can proceed as normal, and in some cases with a warning. The extensions can include standardized extensions (e.g., X.509, RFC 5280), as well as proprietary extensions used by the CA (the issuer) and/or the certificate subject.

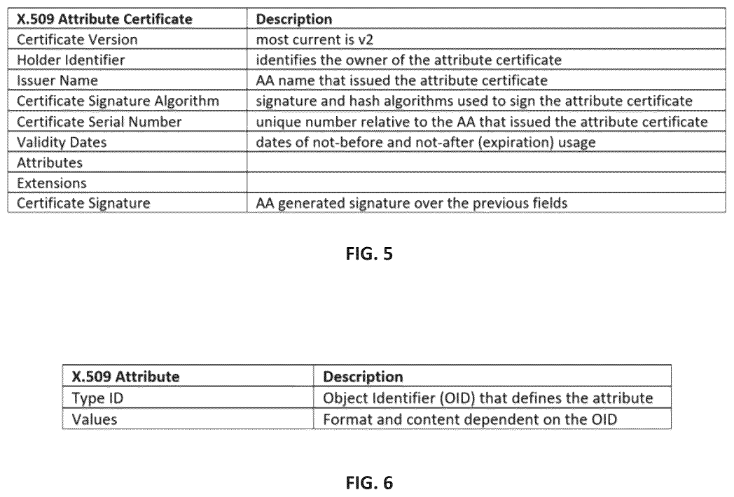

An attribute certificate (e.g., the attribute certificate 103) contains information or metadata of a public key certificate, including the identifying information and the attributes as described herein. An attribute certificate contains the public key information, without containing the public key information itself. The attribute certificate is a signed object including basic fields and extensions. For example, ITU-T X.509 defines a structure and content for attribute certificates, an example of which is shown in the table in FIG. 5. The attribute certificate shown in FIG. 5 includes various fields including at least a certificate version, a holder identifier, an issuer name (e.g., the AA), a certificate signature algorithm, a certificate serial number, validity dates, attributes, extensions, and certificate signature.

The certificate version field of the attribute certificate defines a version of the attribute certificate, e.g., v2. The holder identifier field of the attribute certificate identifies an owner of the attribute certificate, which can be the same as the owner identified by the subject name. The issuer name field identifies the name of the AA that issues the attribute certificate. The certificate signature algorithm field identifies the signature and/or hash algorithm used to sign the attribute certificate by the AA. The certificate serial number field of the attribute certificate comprises a unique number relative to the AA that issues the attribute certificate. The validity dates field of the attribute certificate includes a not-before date (e.g., issuance date) before which the attribute certificate is invalid and a not-after date (e.g., expiration date) after which the attribute certificate is invalid. The attributes field of the attribute certificate includes the identifying information and the attributes of the public key certificate as described herein. The extensions field of the attribute certificate include various types of extensions for the attribute certificate, with subfields such as those shown in FIG. 4. The certificate signature field of the attribute certificate includes the signature of the AA 115 over the other fields of the attributes certificate.

FIG. 6 is a table illustrating subfields of each attributes field of the attribute certificate, according to various arrangements. As shown, each attributes field includes subfields such as type ID and attribute values. The type ID subfield include an OID that defines type of the attribute, such as the identifying information of a public key certificate, a type of attribute, and so on. The attribute values subfield includes a format and content of the attribute, depending on the OID. For type ID of whether a public key certificate is using PQC, the attribute values subfield can include “0” indicating that the public key certificate is defined using classical/legacy/non-PQC protocol and “1” indicating that the public key certificate is defined using PQC protocol.

In some examples, the attribute certificate can include a reference or an ID (e.g., the certificate serial number) of the associated public key certificate in the attributes field. For example, the attributes field of the attribute certificate 103 can include an attribute identified by the type ID indicating 1) a public key certificate type, and 2) one or more values indicating an ID (e.g., the certificate serial number) of the certificates 110 or 150.

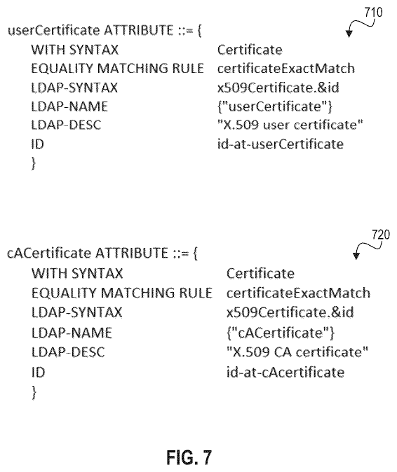

FIG. 7 shows an example of a structure of a certificate attribute 710 and an example of a structure of a CA certificate attribute 720, according to various arrangements. In some examples, the certificate attributes 710 and 720 are structures of an attribute in the attribute certificate 103 (e.g., such as that shown in FIG. 5). The certificate attribute 710 can include a userCertificate which enables an exact match to a subject public key certificate as defined in X.509. The certificate attribute 720 can include a cACertificate which enables an exact match to the issuing CA certificate that enables any subject public key certificate as defined in X.509. In some examples, the WITH SYNTAX field of each of the certificate attribute 710 or 720 includes the identifying information of the certificates 110 and 150. The EQUALITY MATCHING RULE field includes at least one attribute of each of one or more public key certificates.

In some examples, the attribute certificate 103 can be pinned for whitelisting. In some examples, the attribute certificate has a shorter validity as compared to that of the public key certificate for which the attribute certificate contains attributes. In some examples, the attribute certificate has a longer validity as compared to that of the public key certificate for which the attribute certificate contains attributes. In some examples, the attribute certificate can use the exact matching (e.g., shown in FIG. 7) or partial matching using wildcard notation to match the attributes of the public key certificate with the capabilities of the relying party device 102. In some examples, the attribute certificate 103 as described herein is applicable to any industry using PKI for any purpose, including key management to exchange symmetric keys and digital signatures for payments, medical, intellectual property, code signing, and so on.

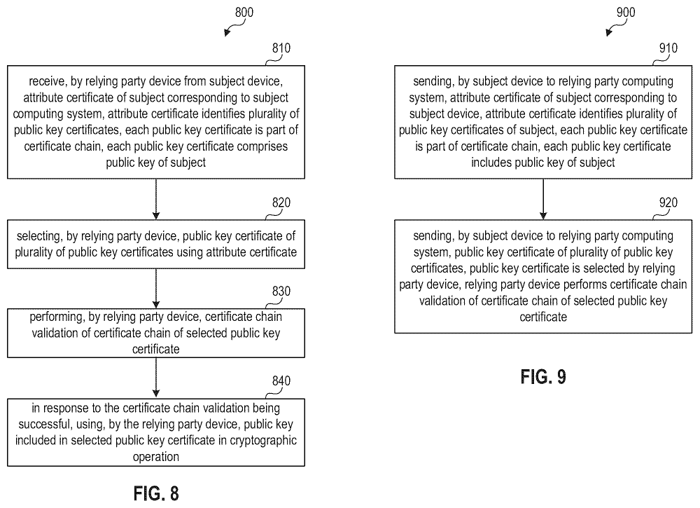

FIG. 8 is a flowchart diagram illustrating an example method 800 for PACT performed by a relying party device 102, according to various arrangements. At 810, the relying party device 102 receives from the subject device 101 an attribute certificate 103 of a subject corresponding to the subject device 101. The attribute certificate 103 identifies a plurality of public key certificates 110 and 150. Each of the plurality of public key certificates 110 and 150 is part of a certificate chain 111 or 151. Each of the plurality of public key certificates 110 and 150 includes a public key 114 or 154 of the subject.

At 820, the relying party device 102 selects a public key certificate of the plurality of public key certificates 110 and 150 using the attribute certificate 103. At 830, the relying party device 102 performs certificate chain validation of a certificate chain of the selected public key certificate. At 840, in response to the certificate chain validation being successful, the relying party device 102 uses a public key included in the selected public key certificate in a cryptographic operation.

FIG. 9 is a flowchart diagram illustrating an example method 900 for PACT performed by a subject device 101, according to various arrangements. At 910, the subject device 101 sends to a relying party device 102 an attribute certificate 103 of a subject corresponding to the subject device 101. The attribute certificate 103 identifies a plurality of public key certificates 110 and 150 of the subject. Each of the plurality of public key certificates 110 and 150 is part of a certificate chain 111 or 151. Each of the plurality of public key certificates 110 and 150 includes a public key 114 or 154 of the subject. At 920, the subject device 101 sends to a relying party device 102 a public key certificate of the plurality of public key certificates 110 and 150. The public key certificate is selected by the relying party device 102. The relying party device 102 performs certificate chain validation of a certificate chain of the selected public key certificate.

As utilized herein, the terms “approximately,” “substantially,” and similar terms are intended to have a broad meaning in harmony with the common and accepted usage by those of ordinary skill in the art to which the subject matter of this disclosure pertains. It should be understood by those of ordinary skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

Although only a few arrangements have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter described herein. For example, elements shown as integrally formed may be constructed of multiple components or elements, the position of elements may be reversed or otherwise varied, and the nature or number of discrete elements or positions may be altered or varied. The order or sequence of any method processes may be varied or re-sequenced according to alternative arrangements. Other substitutions, modifications, changes, and omissions may also be made in the design, operating conditions and arrangement of the various exemplary arrangements without departing from the scope of the present disclosure.

The arrangements described herein have been described with reference to drawings. The drawings illustrate certain details of specific arrangements that implement the systems, methods and programs described herein. However, describing the arrangements with drawings should not be construed as imposing on the disclosure any limitations that may be present in the drawings.

It should be understood that no claim element herein is to be construed under the provisions of 35 U.S.C. § 112 (f), unless the element is expressly recited using the phrase “means for.”

As used herein, the term “circuit” may include hardware structured to execute the functions described herein. In some arrangements, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some arrangements, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some arrangements, the one or more processors may be embodied in various ways. The one or more processors may be constructed in a manner sufficient to perform at least the operations described herein. In some arrangements, the one or more processors may be shared by multiple circuits (e.g., circuit A and circuit B may include or otherwise share the same processor which, in some example arrangements, may execute instructions stored, or otherwise accessed, via different areas of memory). Alternatively or additionally, the one or more processors may be structured to perform or otherwise execute certain operations independent of one or more co-processors. In other example arrangements, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some arrangements, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the arrangements might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), a distributed ledger (e.g., a blockchain), etc. In some arrangements, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other arrangements, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example arrangements described herein.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative arrangements. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web arrangements of the present disclosure could be accomplished with standard programming techniques with rule based logic and other logic to accomplish the various database searching steps, correlation steps, comparison steps and decision steps.

The foregoing description of arrangements has been presented for purposes of illustration and description. It is not intended to be exhaustive or to limit the disclosure to the precise form disclosed, and modifications and variations are possible in light of the above teachings or may be acquired from this disclosure. The arrangements were chosen and described in order to explain the principals of the disclosure and its practical application to enable one skilled in the art to utilize the various arrangements and with various modifications as are suited to the particular use contemplated. Other substitutions, modifications, changes and omissions may be made in the design, operating conditions and arrangement of the arrangements without departing from the scope of the present disclosure as expressed in the appended claims.

What is claimed is:

1. A system, comprising:
at least one memory; and
at least one processor that processes bits, the at least one processor configured to:
receive, by a relying party device from a subject device, an attribute certificate of a subject corresponding to the subject device, wherein the attribute certificate identifies a plurality of public key certificates, each of the plurality of public key certificates is part of a certificate chain, and each of the plurality of public key certificates comprises a public key of the subject;
select, by the relying party device, a public key certificate of the plurality of public key certificates using the attribute certificate;
perform, by the relying party device, certificate chain validation of a certificate chain of the selected public key certificate; and
in response to the certificate chain validation being successful, use, by the relying party device, a public key comprised in the selected public key certificate in a cryptographic operation.

2. The system of claim 1, wherein the at least one processor configured to receive, by the relying party device from the subject device, at least one of the plurality of public key certificates.

3. The system of claim 1, wherein the at least one processor configured to receive, by the relying party device from the subject device, the plurality of public key certificates, wherein the attribute certificate is received after the plurality of public key certificates are received.

4. The system of claim 1, wherein the at least one processor configured to receive, by the relying party device from the subject device, the selected public key certificate, wherein the attribute certificate is received before the selected public key certificate is received.

5. The system of claim 1, wherein the at least one processor configured to receive, by the relying party device from the subject device, the plurality of public key certificates and the attribute certificate simultaneously.

6. The system of claim 1, wherein the cryptographic operation comprises at least one of encrypting data, encrypting cryptographic material, verifying a signature, or establishing a cryptographic key.

7. The system of claim 1, wherein the at least one processor configured to validate, by the relying party device, the attribute certificate before selecting the public key certificate of the plurality of public key certificates using the attribute certificate.

8. The system of claim 1, wherein
the attribute certificate comprises at least one attribute of each of the plurality of public key certificates; and
selecting the public key certificate of the plurality of public key certificates using the attribute certificate comprises selecting the public key certificate of the plurality of public key certificates using the at least one attribute of each of the plurality of public key certificates.

9. The system of claim 8, wherein the at least one attribute of each of the plurality of public key certificates comprises one or more of:
a protocol of a public key in each of the plurality of public key certificates;
a key management or signature algorithm of the public key in each of the plurality of public key certificates;
a standard setting body that sets a standard or specification followed by the key management or signature algorithm of the public key in each of the plurality of public key certificates;
a version number or agreement number of each of the plurality of public key certificates;
a specification of the public key in each of the plurality of public key certificates;
a key length of the public key in each of the plurality of public key certificates;
an expiration date of each of the plurality of public key certificates;
a type of access allowed using the public key in each of the plurality of public key certificates; or
an application allowed using each of the plurality of public key certificates.

10. The system of claim 8, wherein the at least one attribute of each of the plurality of public key certificates comprises an indication that a public key in each of the plurality of public key certificates is defined using a Post Quantum Cryptography (PQC) protocol or a classical protocol.

11. The system of claim 10, wherein the at least one processor is further configured to determine, by the relying party device, that the relying party device is configured for the PQC protocol, wherein the selected public key certificate is defined using the PQC protocol.

12. The system of claim 10, wherein the at least one processor is further configured to determine, by the relying party device, that the relying party device is not configured for the PQC protocol, wherein the selected public key certificate is defined using the classical protocol.

13. The system of claim 1, wherein each of the plurality of public key certificates is a single-key certificate.

14. A system, comprising:
at least one memory; and
at least one processor that processes quantum bits, the at least one processor configured to:
send, by a subject device to a relying party device, an attribute certificate of a subject corresponding to the subject device, wherein the attribute certificate identifies a plurality of public key certificates of the subject, each of the plurality of certificates is part of a certificate chain, and each of the plurality of certificates comprises a public key of the subject; and
send, by the subject device to the relying party device, a public key certificate of the plurality of public key certificates, wherein the public key certificate is selected by the relying party device, and wherein the relying party device performs certificate chain validation of a certificate chain of the selected public key certificate.

15. The system of claim 14, wherein
the attribute certificate comprises at least one attribute of each of the plurality of public key certificates; and
the selected public key certificate is selected using the at least one attribute of each of the plurality of public key certificates.

16. The system of claim 15, wherein the at least one attribute of each of the plurality of public key certificates comprises one or more of:
a protocol of a public key in each of the plurality of public key certificates;
a key management or signature algorithm of the public key in each of the plurality of public key certificates;
a standard setting body that sets a standard or specification followed by the key management or signature algorithm of the public key in each of the plurality of public key certificates;
a version number or agreement number of each of the plurality of public key certificates;
a specification of the public key in each of the plurality of public key certificates;
a key length of the public key in each of the plurality of public key certificates;
an expiration date of each of the plurality of public key certificates;
a type of access allowed using the public key in each of the plurality of public key certificates; or
an application allowed using each of the plurality of public key certificates.

17. The system of claim 15, wherein the at least one attribute of each of the plurality of public key certificates comprises an indication that a public key in each of the plurality of public key certificates is defined using a Post Quantum Cryptography (PQC) protocol or a classical protocol.

18. The system of claim 17, wherein the relying party device determines that the relying party device is configured for the PQC protocol, wherein the selected public key certificate is defined using the PQC protocol.

19. The system of claim 17, wherein the relying party device determines that the relying party device is not configured for the PQC protocol, wherein the selected public key certificate is defined using the classical protocol.

20. At least one non-transitory computer-readable medium comprising computer-readable instructions, that, when executed, causes at least one processor to:
receive, from a subject device, an attribute certificate of a subject corresponding to the subject device, wherein the attribute certificate identifies a plurality of public key certificates, each of the plurality of public key certificates is part of a certificate chain, each of the plurality of public key certificates comprises a public key of the subject;
select a public key certificate of the plurality of public key certificates using the attribute certificate;
perform certificate chain validation of a certificate chain of the selected public key certificate; and
in response to the certificate chain validation being successful, use a public key comprised in the selected public key certificate in a cryptographic operation.
